(19) United States
(12) Patent Application Publication
(10) Pub. No.: US 2014/0052322 A1
(43) Pub. Date: Feb. 20, 2014

(54) SECONDARY BATTERY, METHOD FOR MANUFACTURING SECONDARY BATTERY, POSITIVE ELECTRODE FOR SECONDARY BATTERY, METHOD FOR MANUFACTURING POSITIVE ELECTRODE FOR SECONDARY BATTERY, BATTERY PACK, ELECTRONIC INSTRUMENT, ELECTRIC VEHICLE, ELECTRICAL POWER SYSTEM AND ELECTRIC POWER STORAGE POWER SOURCE

(71) Applicant: Kazumasa Takeshi, Kanagawa (JP)

(72) Inventor: Kazumasa Takeshi, Kanagawa (JP)

(73) Assignee: Sony Corporation, Tokyo (JP)

(21) Appl. No.: 14/113,548

(22) PCT Filed: Apr. 12, 2012
(86) PCT No.: PCT/JP2012/060530

§ 371 Date: Oct. 23, 2013

(30) Foreign Application Priority Data
May 11, 2011 (JP) 2011-106024

(51) Int. Cl. H01M 4/66; B60L 11/18; H01M 10/04

(52) U.S. Cl. CPC H01M 4/663; H01M 10/04; B60L 11/1861
USPC 701/22; 429/188; 429/231.8; 429/163; 29/623.1

(57) ABSTRACT

The secondary battery includes a positive electrode including an electroconductive substrate, a plurality of carbon nanotubes that are disposed in a standing manner on the electroconductive substrate, and sulfur that is retained at least a part of spaces among at least the carbon nanotubes. The negative electrode includes a material that stores and releases lithium-ions, and a nonaqueous electrolyte including lithium-ions is used as the electrolyte.

### TECHNICAL FIELD

The present disclosure relates to a secondary battery, a method for manufacturing a secondary battery, a positive electrode for a secondary battery, a method for manufacturing a positive electrode for a secondary battery, a battery pack, an electronic instrument, an electric vehicle, an electrical power system and an electric power storage power source. More specifically, the present disclosure relates to a secondary battery having a positive electrode comprising sulfur and a positive electrode therefor, and methods for manufacturing those and applications of this secondary battery.

### BACKGROUND ART

As a secondary battery for which significant improvement of electricity storage performance is expected as compared to a lithium-ion battery, a lithium-sulfur battery using sulfur as a positive electrode active substance gains attention (for example, see Patent Documents 1 and 2). In conventional and general lithium-sulfur batteries, sulfur is used in a positive electrode, metallic lithium is used in a negative electrode, and a nonaqueous electrolyte comprising lithium-ions (Li⁺) is used in an electrolyte.

### CITATION LIST

### Patent Document

Patent Document 1: Japanese Patent Application Laid-Open No. 2005-251473
Patent Document 2: Japanese Patent Application Laid-Open No. 2009-76260

### Non-Patent Document

Non-patent Document 1: Internet <URL:http://www.microphase.jp/j_product-0101.html>[searched on Nov. 8, 2010]

### SUMMARY OF THE INVENTION

### Problems to be Solved by the Invention

However, conventional lithium-sulfur batteries had a problem that the charge-discharge cycle characteristic gradually decreases since the sulfur contained in the positive electrode reacts with the lithium-ions in the electrolyte and is gradually eluted as Li₂Sₓ into the electrolyte during the processes of charging and discharging.

Therefore, the problem to be solved by the present disclosure is to provide a secondary battery that can suppress the elution of sulfur contained in a positive electrode into an electrolyte and can also suppress decrease in charge-discharge cycle characteristic, and a method for manufacturing the secondary battery.

Another problem to be solved by the present disclosure is to provide a positive electrode for a secondary battery, which can suppress the elution of sulfur contained in a positive electrode into an electrolyte and can also suppress decrease in the charge-discharge cycle characteristic of a secondary battery, and a method for manufacturing the positive electrode.

Still another problem to be solved by the present disclosure is to provide high-performance battery pack, electronic instrument, electric vehicle, electrical power system and electric power storage power source using the above-mentioned excellent secondary battery.

### Solutions to Problems

In order to solve the above-mentioned problems, the present disclosure is a secondary battery comprising a positive electrode comprising sulfur,

a negative electrode comprising a material that stores and releases lithium-ions,

and a nonaqueous electrolyte comprising lithium-ions, and the positive electrode comprises

an electroconductive substrate,

a plurality of carbon nanotubes disposed in a standing manner on the electroconductive substrate,

and sulfur that is retained in at least apart of spaces among at least the carbon nanotubes.

Furthermore, the present disclosure is a method for manufacturing a secondary battery, including a step of forming a positive electrode by retaining sulfur in at least a part of spaces among at least a plurality of carbon nanotubes that are disposed in a standing manner on an electroconductive substrate.

Furthermore, the present disclosure is a positive electrode for a secondary battery, including an electroconductive substrate,

a plurality of carbon nanotubes that are disposed in a standing manner on the electroconductive substrate, and

sulfur that is retained at least apart of spaces among at least the carbon nanotubes.

Furthermore, the present disclosure is a method for manufacturing a positive electrode for a secondary battery, including forming a positive electrode by retaining sulfur in at least a part of spaces among at least a plurality of carbon nanotubes that are disposed in a standing manner on an electroconductive substrate.

Furthermore, the present disclosure is a battery pack including

a secondary battery,

a control means that is configured to perform controlling relating to the secondary battery, and

an exterior packaging that is configured to enclose the secondary battery, wherein the secondary battery includes

a positive electrode including sulfur,

a negative electrode including a material that stores and releases lithium-ions, and

a nonaqueous electrolyte including lithium-ions, and the positive electrode includes

an electroconductive substrate,

a plurality of carbon nanotubes disposed in a standing manner on the electroconductive substrate,

and sulfur that is retained in at least a part of spaces among at least the carbon nanotubes.

In this battery pack, the control means performs, for example, controlling of charging and discharging, overdischarging or overcharging relating to the secondary battery.

Furthermore, the present disclosure is an electronic instrument, which is supplied with electrical power by a secondary battery, wherein the secondary battery includes a positive electrode including sulfur,

a negative electrode including a material that stores and releases lithium-ions,

and a nonaqueous electrolyte including lithium-ions, and the positive electrode includes an electroconductive substrate,

a plurality of carbon nanotubes disposed in a standing manner on the electroconductive substrate,

and sulfur that is retained in at least apart of spaces among at least the carbon nanotubes.

Furthermore, the present disclosure is an electric vehicle including

a conversion device that is configured to be supplied with electrical power by a secondary battery and to convert the electrical power into driving force of the vehicle,

and a control device that is configured to perform information processing relating to the control on the vehicle on the basis of information relating to the secondary battery,

wherein the secondary battery includes

a positive electrode including sulfur,

a negative electrode including a material that stores and releases lithium-ions, and

a nonaqueous electrolyte including lithium-ions, and the positive electrode includes

an electroconductive substrate,

a plurality of carbon nanotubes disposed in a standing manner on the electroconductive substrate,

and sulfur that is retained in at least apart of spaces among at least the carbon nanotubes.

In this electric vehicle, the conversion device typically rotates a motor by being supplied with electrical power by the secondary battery to thereby generate driving force. This motor can also utilize regenerative energy. Furthermore, the control device performs information processing relating to the control on the vehicle on the basis of the remaining battery level of the secondary battery. This electric vehicle includes, for example, electric automobiles, electric motorcycles, electric bicycles, railroad vehicles and the like, and so-called hybrid automobiles.

Furthermore, the present disclosure is an electrical power system, which is configured to be supplied with electrical power from a secondary battery and/or to supply electrical power from an electrical power source to the secondary battery, wherein the secondary battery includes a positive electrode including sulfur,

a negative electrode including a material that stores and releases lithium-ions,

and a nonaqueous electrolyte including lithium-ions, and the positive electrode includes

an electroconductive substrate,

a plurality of carbon nanotubes disposed in a standing manner on the electroconductive substrate,

and sulfur that is retained in at least apart of spaces among at least the carbon nanotubes.

This electrical power system may be any one as long as it uses electrical power, and also includes a simple electrical power device. This electrical power system includes, for example, smart grid, home energy management systems (HEMSs), vehicles and the like, and is also capable of electric power accumulation.

Furthermore, the present disclosure is an electric power storage power source, which is configured so that an electronic instrument that is supplied with electrical power is connected to the electric power storage power source,

and includes a secondary battery,

wherein the secondary battery includes a positive electrode including sulfur,

a negative electrode including a material that stores and releases lithium-ions,

and a nonaqueous electrolyte including lithium-ions, and the positive electrode includes

an electroconductive substrate,

a plurality of carbon nanotubes disposed in a standing manner on the electroconductive substrate,

and sulfur that is retained in at least a part of spaces among at least the carbon nanotubes.

The purpose of use of this electric power storage power source is not limited, and the electric power storage power source can essentially be used in any electrical power system or electrical power device, and can be used in, for example, smart grid.

In the present disclosure, from the viewpoint of increasing in the amount of the sulfur contained in the positive electrode, it is the most preferable that the sulfur is retained in the spaces among the carbon nanotubes and on the carbon nanotubes. Although the carbon nanotubes are oriented in the approximately vertical direction with respect to the surface of the electroconductive substrate, but are not limited to this, and may be inclined at any angle with respect to the surface of the electroconductive substrate as long as the sulfur can be retained in the spaces among the carbon nanotubes. The carbon nanotubes may be either single-walled carbon nanotubes or multi-walled carbon nanotubes, and are selected as necessary. The carbon nanotubes each has a diameter of preferably 0.8 nm or more and 20 nm or less, but the diameter is not limited to this. Furthermore, although the interval of the carbon nanotubes is selected as necessary, the interval is preferably selected so as to be 20 times or less as large as the diameter of the carbon nanotube since the vertical orientation property tends to decrease when the interval goes beyond 20 times of the diameter of the carbon nanotube. On the other hand, when the interval of the carbon nanotubes becomes too narrow, the amount of the sulfur that can be retained in the spaces among the carbon nanotubes decreases, and thus the capacity of the secondary battery decreases. Therefore, the interval of the carbon nanotubes is selected so as to be, for example, twice or more, preferably five times or more as large as the diameter of the carbon nanotube. The length of the carbon nanotube is selected as necessary, and is typically 100 μm or less, preferably 20 μm or more and 50 μm or less.

In order to retain the sulfur in the spaces among the carbon nanotubes, for example, the sulfur is retained in the spaces among the carbon nanotubes through a process of attaching the sulfur to the carbon nanotubes by spreading microparticular sulfur on the carbon nanotubes or bringing the carbon nanotubes into contact with a solution in which microparticular sulfur is dissolved. Preferably, the sulfur is introduced into the spaces among the carbon nanotubes by attaching the sulfur to the carbon nanotubes by spreading microparticular sulfur on the carbon nanotubes or bringing the carbon nanotubes into contact with a solution in which microparticular sulfur is dissolved, and heating the sulfur to allow flowing.

In the above-mentioned present disclosure, since the sulfur can be strongly retained in the spaces among the plural carbon nanotubes that are disposed in a standing manner on the electroconductive substrate or on the carbon nanotubes, the elution of the sulfur by reacting with the lithium-ions in the electrolyte during the processes of charging and discharging can be effectively prevented.

### Effects of the Invention

According to the present disclosure, a secondary battery that can suppress the elution of sulfur contained in a positive electrode into an electrolyte and can also suppress decrease in charge-discharge cycle characteristic can be realized. Furthermore, high-performance battery pack, electronic instrument, electric vehicle, electrical power system and electric power storage power source can be realized by using this excellent secondary battery.

### BRIEF DESCRIPTION OF DRAWINGS

FIG. 1A is a cross-sectional view showing the positive electrode for a lithium-sulfur battery according to the first embodiment. FIG. 1B is a top view showing the positive electrode for a lithium-sulfur battery according to the first embodiment.

FIGS. 2A to 2C are cross-sectional views for explaining the method for manufacturing the positive electrode for a lithium-sulfur battery according to the first embodiment.

FIG. 3 is a photograph as a substitute for a drawing, showing a scanning electron microscopic image of the cross-sectional surface of the positive electrode for a lithium-sulfur battery prepared in Example 1.

FIG. 4 is a schematic diagram schematically showing the lithium-sulfur battery according to the second embodiment.

FIG. 5 is a schematic diagram showing the change in the charge-discharge capacity of the lithium-sulfur battery manufactured in Example 2.

FIG. 6 is a schematic diagram showing the change in the charge-discharge capacity of the lithium-sulfur battery manufactured in Example 2.

FIG. 7 is a schematic diagram showing the change in the charge-discharge capacity of the lithium-sulfur battery manufactured in Example 2.

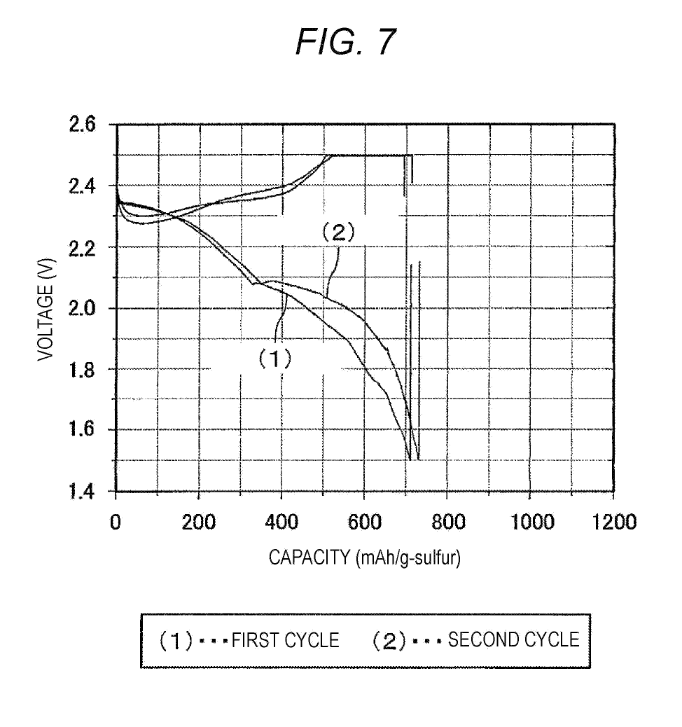

FIG. 8 is an exploded perspective view of the lithium-sulfur battery according to the third embodiment.

FIG. 9 is a cross-sectional view along the line X-X of the wound electrode body of the lithium-sulfur battery shown in FIG. 8.

### MODES FOR CARRYING OUT THE INVENTION

The embodiments for carrying out the invention (hereinafter referred to as “embodiments”) will be explained below. Explanation will be made in the following order.
1. First embodiment (a positive electrode for a lithium-sulfur battery and a method for manufacturing the same)
2. Second embodiment (a lithium-sulfur battery)
3. Third embodiment (a lithium-sulfur battery and a method for manufacturing the same)

### 1. First Embodiment

### [Positive Electrode for Lithium-Sulfur Battery]

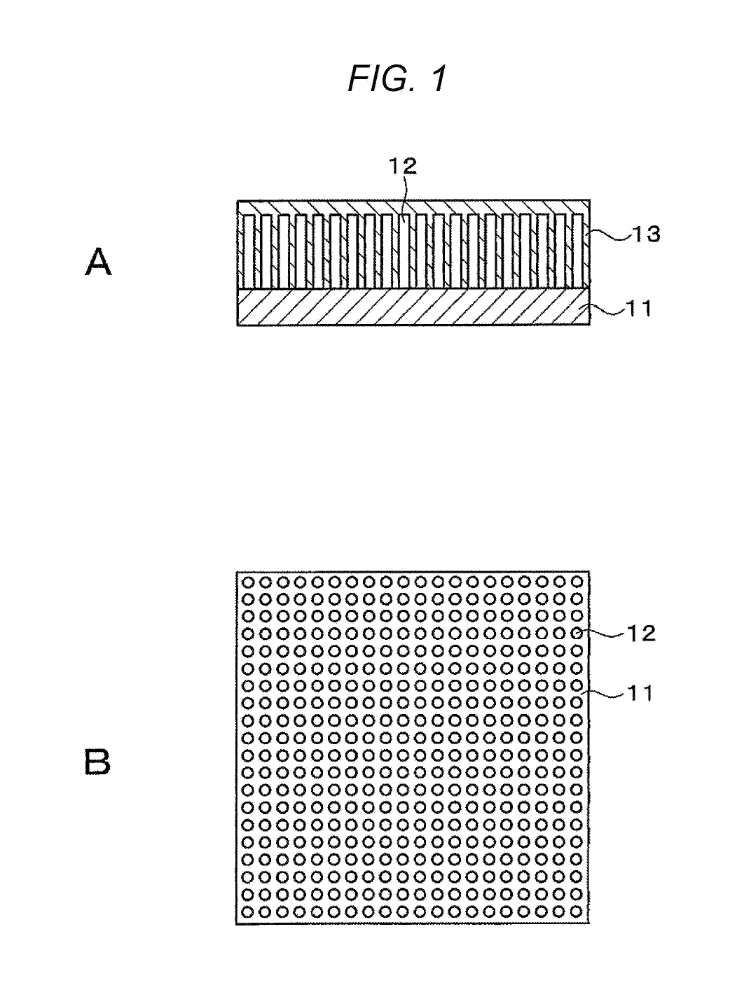

FIG. 1A is a cross-sectional view showing the positive electrode for a lithium-sulfur battery according to the first embodiment, and FIG. 1B is a top view showing this positive electrode for a lithium-sulfur battery.

As shown in FIGS. 1A and 1B, in this positive electrode for a lithium-sulfur battery, a plurality of carbon nanotubes 12 are disposed in a standing manner in a regular disposition or an irregular disposition on the surface of an electroconductive substrate 11. Furthermore, sulfur 13 is retained so as to reach the entirety of the spaces among the carbon nanotubes 12 and on the carbon nanotubes 12. In FIG. 1B, the illustration of the sulfur 13 is omitted.

The diameter of the carbon nanotube 12 is, for example, 0.8 nm or more and 20 nm or less. Furthermore, the length of the carbon nanotube 12 is preferably 20 μm or more and 50 μm or less. The interval of the carbon nanotubes 12 is preferably selected so as to be twice or more and 20 times or less as large as this diameter of the carbon nanotube 12. The intervals of the carbon nanotubes 12 are not necessarily uniform among all the places on the surface of the electroconductive substrate 11, and parts having different intervals may exist depending on the places. FIGS. 1A and 1B shows an example in which the carbon nanotubes 12 are regularly disposed in a square grid pattern. Although the carbon nanotubes 12 are preferably oriented in the approximately vertical direction with respect to the surface of the electroconductive substrate 11, the orientation is not limited to this, and the carbon nanotubes may be inclined at an angle of less than 90° with respect to the surface of the electroconductive substrate 11.

The carbon nanotubes 12 may be either single-walled carbon nanotubes or multi-walled carbon nanotubes (for example, bi-layered carbon nanotubes). Although the method for synthesizing the carbon nanotubes 12 is not specifically limited, for example, they can be synthesized by a laser abrasion process, an electric arc discharge process, a chemical vapor deposition (CVD) process or the like.

Although the electroconductive substrate 11 is not specifically limited as long as the carbon nanotubes 12 can be disposed in a standing manner thereon, examples include substrates formed of various electroconductive materials such as metals (single body metals and alloys), electroconductive oxide materials and electroconductive plastics. Specific examples of the metals include single bodies or alloys (such as stainless steel) of at least one metal selected from the group consisting of aluminum (Al), platinum (Pt), silver (Ag), gold (Au), ruthenium (Ru), rhodium (Rh), osmium (Os), niobium (Nb), molybdenum (Mo), indium (In), iridium (Ir), zinc (Zn), manganese (Mn), iron (Fe), nickel (Ni), cobalt (Co), titanium (Ti), vanadium (V), chromium (Cr), palladium (Pd), rhenium (Re), tantalum (Ta), tungsten (W), zirconium (Zr), germanium (Ge) and hafnium (Hf). This electroconductive substrate 11 may be one obtained by forming an electroconductive layer on a non-electroconductive substrate. The thickness of the electroconductive substrate 11 is selected as necessary, and is, for example, 20 μm or more and 50 μm or less.

[Method for Manufacturing Positive Electrode for Lithium-Sulfur Battery]

This positive electrode for a lithium-sulfur battery can be manufactured as follows.

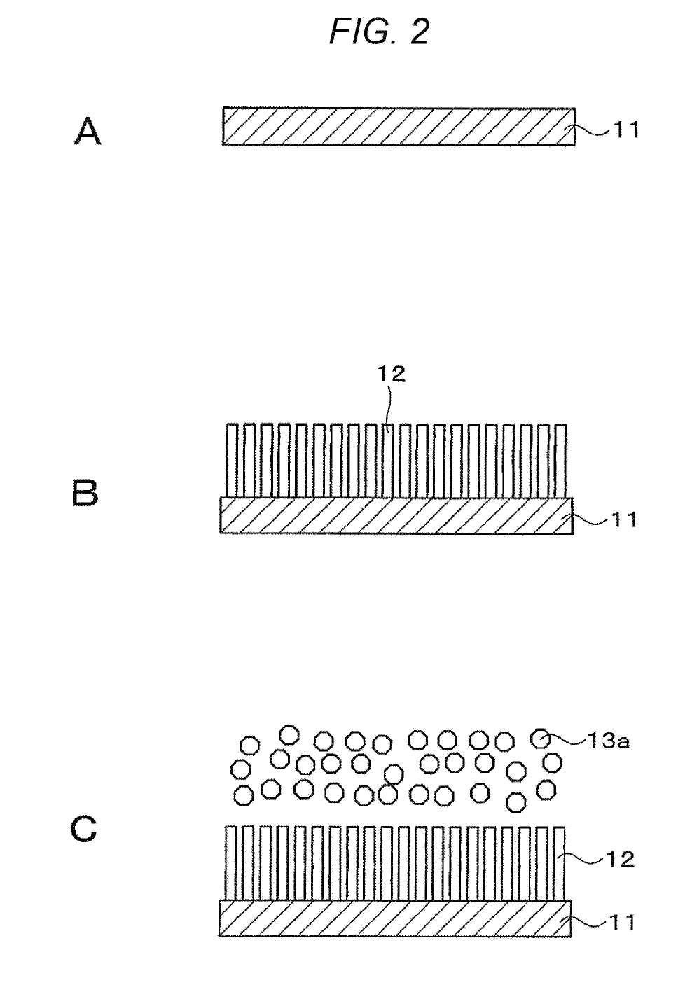

As shown in FIG. 2A, at first, the electroconductive substrate 11 is prepared.

Subsequently, as shown in FIG. 2B, a plurality of carbon nanotubes 12 are disposed in a standing manner on the electroconductive substrate 11.

Subsequently, as shown in FIG. 2C, an aggregate of sulfur microparticles 13a formed of cyclic sulfur (S₈) is attached onto the carbon nanotubes 12. For this purpose, for example, a powder formed of the sulfur microparticles 13a is spread on the carbon nanotubes 12, or a solution in which the sulfur microparticles 13 are dissolved in a solvent is applied onto the carbon nanotubes 12. In the case when a solution in which the sulfur microparticles 13a are dissolved in a solvent is applied onto the carbon nanotubes 12, the solvent is subsequently removed by drying or the like.

Subsequently, the electroconductive substrate 11 on which the carbon nanotubes 12 and sulfur microparticles 13a have been formed as above is heated to thereby allow the flowing of the sulfur (S₈) that constitutes the sulfur microparticles 13a. The heating is performed in, for example, a heating furnace or the like. Although the heating temperature is not specifically limited as long as it is a temperature at which the sulfur (S₈) flows, the heating temperature is, for example, 150° C. or more and 170° C. or less. This heating is performed preferably under an inert gas atmosphere such as argon (Ar) and nitrogen (N₂) so as to prevent the oxidation of the carbon nanotubes 12 and sulfur microparticles 13a. The sulfur microparticles 13a that have been allowed for flowing in such way are introduced into the spaces among the carbon nanotubes 12. By sufficiently increasing the amount of spreading or amount of attaching of the sulfur microparticles 13a, the sulfur 13 is retained in the entirety of the spaces among the carbon nanotubes 12 and on the carbon nanotubes 12.

By the above-mentioned way, the intended positive electrode for a lithium-sulfur battery is manufactured.

### EXAMPLE 1

A positive electrode for a lithium-sulfur battery was prepared as follows.

A substrate made of stainless steel having a thickness of 50 μm was used as the electroconductive substrate 11.

Bi-layered carbon nanotubes as the carbon nanotubes 12 were vertically oriented on the surface of this substrate made of stainless steel. As the method for vertically orienting this bi-layered carbon nanotubes, the method described in Non-patent Document 1 was used. The bi-layered carbon nanotubes each has a diameter of more than ten angstroms and a length of 30 μm.

Subsequently, a powder of sulfur microparticles formed of cyclic sulfur (S₈) in a necessary amount is spread on the bi-layered carbon nanotubes that have been vertically oriented on the surface of the substrate made of stainless steel. The weight ratio of the sulfur to be spread and the bi-layered carbon nanotubes was set to 40:60.

Subsequently, heating was performed in an argon (Ar) gas atmosphere for 12 hours at 160° C., which is higher than the melting point of the cyclic sulfur (S₈). By this heating, the cyclic sulfur (S₈) flows, and the cyclic S₈ is cleaved to form linear sulfur.

After performing heating in such way, the sulfur reached and was retained in the entirety of the spaces among the bi-layered carbon nanotubes vertically oriented on the surface of the substrate made of stainless steel and on the bi-layered carbon nanotubes.

By the above-mentioned way, a positive electrode for a lithium-sulfur battery is prepared.

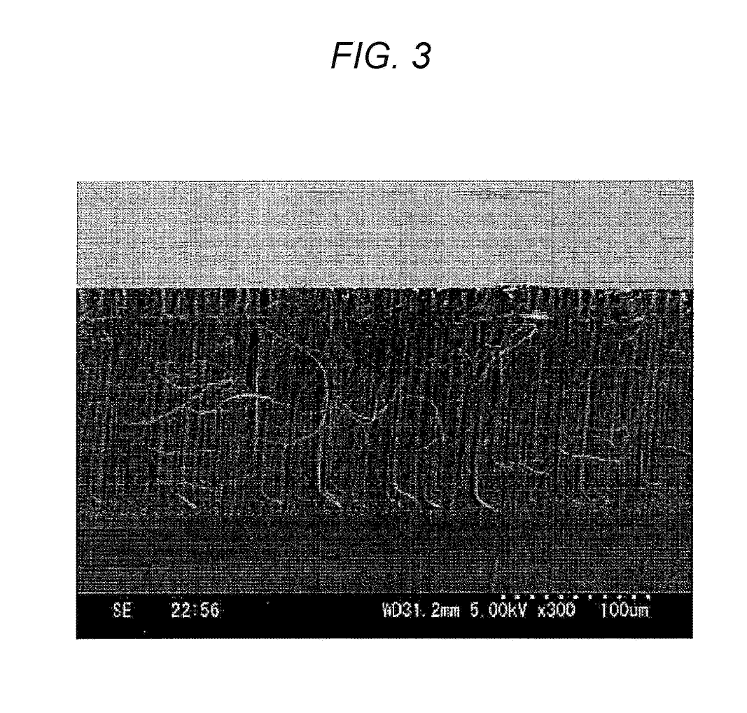

FIG. 3 shows an electron microscopic photograph obtained by photographing the cross-sectional surface of the positive electrode for a lithium-sulfur battery prepared as above by a scanning electron microscope (SEM). It is understood from FIG. 3 that the sulfur is retained in the entirety of the spaces among the bi-layered carbon nanotubes vertically oriented on the surface of the substrate made of stainless steel and on the bi-layered carbon nanotubes.

As mentioned above, according to this first embodiment, a novel positive electrode for a lithium-sulfur battery in which the sulfur 13 is retained in the entirety of the spaces among the plural carbon nanotubes 12 that are vertically oriented on the surface of the electroconductive substrate 11 and on the bi-layered carbon nanotubes 12 can be obtained. According to this positive electrode for a lithium-sulfur battery, since the sulfur can be strongly retained on the carbon nanotubes 12, in the case when a lithium-sulfur battery is constituted by using this positive electrode for a lithium-sulfur battery, the elution of the sulfur as Li₂Sₓ into an electrolyte from this positive electrode for a lithium-sulfur battery can be effectively suppressed.

### 2. Second Embodiment

### [Lithium-Sulfur Battery]

Subsequently, the second embodiment will be explained. In this second embodiment, the positive electrode for a lithium-sulfur battery according to the first embodiment is used as a positive electrode of a lithium-sulfur battery as a secondary battery.

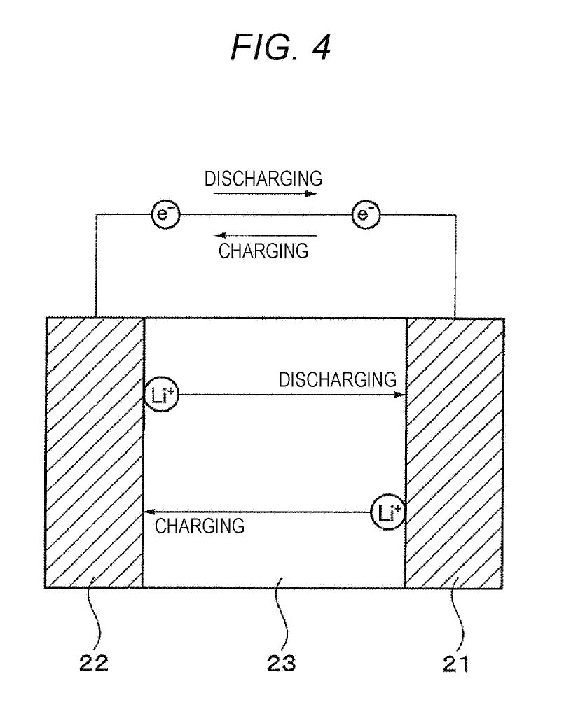

FIG. 4 schematically shows the basic constitution of this lithium-sulfur battery.

As shown in FIG. 4, this lithium-sulfur battery has a structure in which a positive electrode 21 and a negative electrode 22 are facing each other through an electrolyte 23. A separator is disposed between the positive electrode 21 and negative electrode 22, and the illustration thereof is omitted in FIG. 4. As the positive electrode 21, the positive electrode for a lithium-sulfur battery according to the first embodiment is used. As the negative electrode 22, a negative electrode formed of metallic lithium is used.

The electrolyte 23 may be any of a liquid, a gel and a solid. In the case when the electrolyte 23 is a gel or solid, macromolecules such as polyvinylidene fluoride (PVDF), hexafluropropylene (HFP), polyvinylidene fluoride-hexafluropropylene (PVDF-HEP), polyaniline (PAN) and polyethylene oxide (PEO) may be used, or polymers may be used besides these macromolecules.

In the case when an electrolyte is used as the electrolyte 23, as this electrolyte, for example, solutions of lithium salts in organic solvents or mixed solvents of two or more solvents, which have been used in conventionally-known lithium ion batteries, capacitors and the like, can be used. As these organic solvents, for example, carbonates such as ethylene carbonate (EC), propylene carbonate (PC), diethyl carbonate (DEC), dimethyl carbonate (DMC), methylethyl carbonate (MEC) and vinylene carbonate (VC), cyclic esters such as γ-butyrolactone (GBL), γ-valerolactone, 3-methyl-γ-butyrolactone and 2-methyl-γ-butyrolactone, cyclic ethers such as 1,4-dioxane, 1,3-dioxolane, tetrahydrofuran, 2-methyltetrahydrofuran (MTHF), 3-methyl-1,3-dioxolane and 2-methyl-1,3-dioxolane, chain ethers such as 1,2-dimethoxyethane (DME), 1,2-diethoxyethane (DEE), diethyl ether, dimethyl ether, methyl ethyl ether and dipropyl ether, and the like can be used. As the organic solvents, in addition to those mentioned above, for example, methyl propionate (MPR), ethyl propionate (EPR), ethylene sulfite (ES), cyclohexylbenzene (CHB), tetraphenylbenzene (tPB), ethyl acetate (EA), acetonitrile (AN) and the like can also be used.

As the lithium salt to be dissolved in the electrolyte solution, for example, any one of or a mixture of two or more of LiSCN, LiBr, LiI, LiClO₄, LiASF₆, LiSO₃CF₃, LiSO₃CH₃, LiBF₄, LiB(Ph)₄, LiPF₆, LiC(SO₂CF₃)₃, LiN(SO₂CF₃)₂ and the like can be used.

For improving the various characteristics of the lithium-sulfur battery, various materials other than those mentioned above can be added to the electrolyte 23 as necessary. Examples of these materials may include imide salts, sulfonated compounds, aromatic compounds halogen-substituted forms of these, and the like.

### [Operation of Lithium-Sulfur Battery]

In this lithium-sulfur battery, during charging, electricity is accumulated by converting electric energy to chemical energy by the transfer of the lithium-ions (Li⁺) from the positive electrode 21 to the negative electrode 22 through the electrolyte 23. During discharging, the lithium-ions return from the negative electrode 22 to the positive electrode 21 through the electrolyte 23 to thereby generate electric energy.

### EXAMPLE 2

A lithium-sulfur battery was prepared as follows.

A lithium-sulfur battery was prepared by using the positive electrode for a lithium-sulfur battery of Example 1 as a positive electrode, metallic lithium as a negative electrode and 0.5 M LiTFSI+0.4 M LiNO₃ DOL/DME as an electrolyte solution. Three lithium-sulfur batteries are prepared and designated as samples 1 to 3.

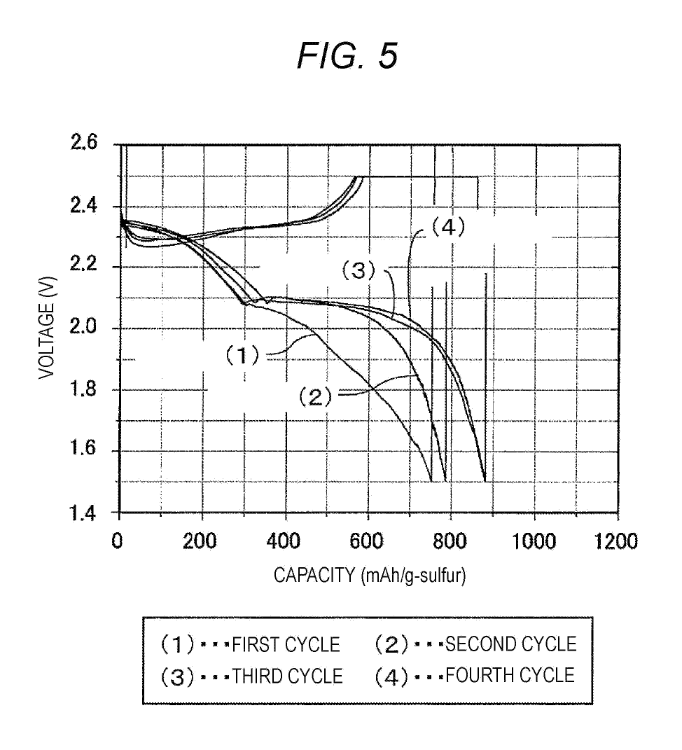

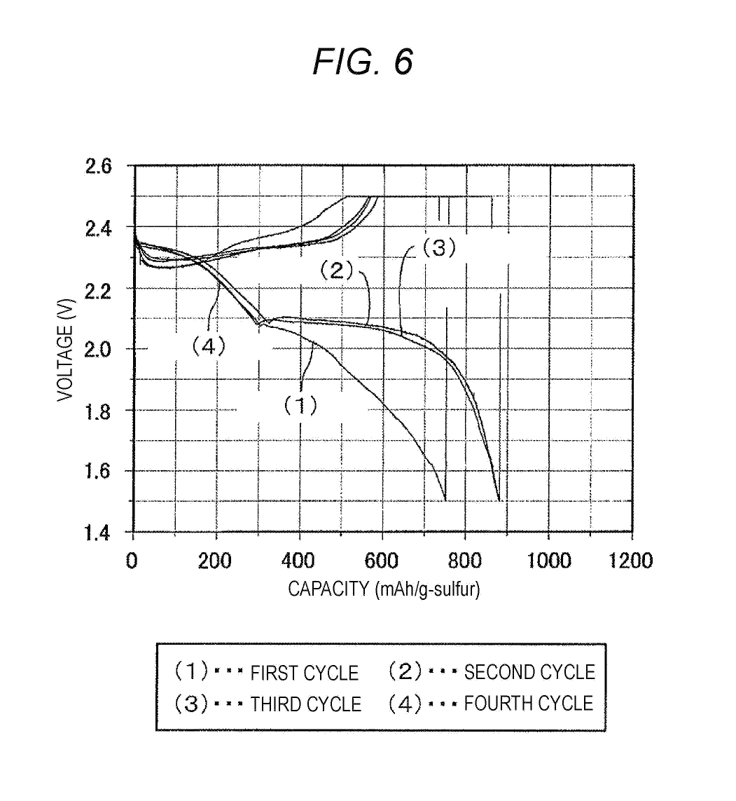

The changes in the charge-discharge capacities of the lithium-sulfur batteries of samples 1 to 3 were measured. The results are shown in FIGS. 4 to 6. It is understood from FIGS. 4 to 6 that the decrease in the charge-discharge characteristic is suppressed even the number of cycles of charging and discharging increases.

According to this second embodiment, since the positive electrode for a lithium-sulfur battery according to the first embodiment is used in the positive electrode, the elution of the sulfur as Li₂Sₓ into the electrolyte 23 from the positive electrode 21 can be effectively suppressed, and thus the decrease in the charge-discharge characteristic of the lithium-sulfur battery can be suppressed.

This lithium-sulfur battery can be mounted on, for example, driving power sources or auxiliary power sources of note type personal computers, PDAs (personal digital assistants), mobile phones, cordless handsets for cordless phones, video movies, digital still cameras, digital books, electronic dictionaries, portable music players, radios, headphones, game machines, navigation systems, memory cards, cardiac pacemakers, hearing aids, power tools, electric shavers, refrigerators, air-conditioners, television sets, stereo units, water heaters, microwave ovens, dishwashers, laundry machines, driers, lighting apparatuses, toys, medical equipments, robots, load conditioners, traffic signals, railroad vehicles, golf carts, electric carts and electric automobiles (including hybrid automobiles), and electric power storage power sources for buildings including residential houses or power generation equipments, or can be used for supplying electrical power to these. In an electric automobile, a conversion device that converts electrical power to driving force by supplying electrical power is generally a motor. The control device that performs information processing relating to the control on a vehicle include a control device that performs indication of a remaining battery level on the basis of information relating to a remaining battery level of a battery, and the like. This lithium-sulfur battery can also be used as an electric storage device in so-called smart grid. It should be noted that such an electric power accumulation device is capable not only of supplying electric power but also of accumulating electric power by receiving electric power supplied from another electric power source. As the other electrical power source, for example, thermal power generation, nuclear power generation, water power generation, solar batteries, wind power generation, geothermal energy, fuel batteries (including bio-fuel batteries) and the like can be used.

### 3. Third Embodiment

### [Lithium-Sulfur Battery]

In the third embodiment, a specific constitutional example of the lithium-sulfur battery of the second embodiment will be explained.

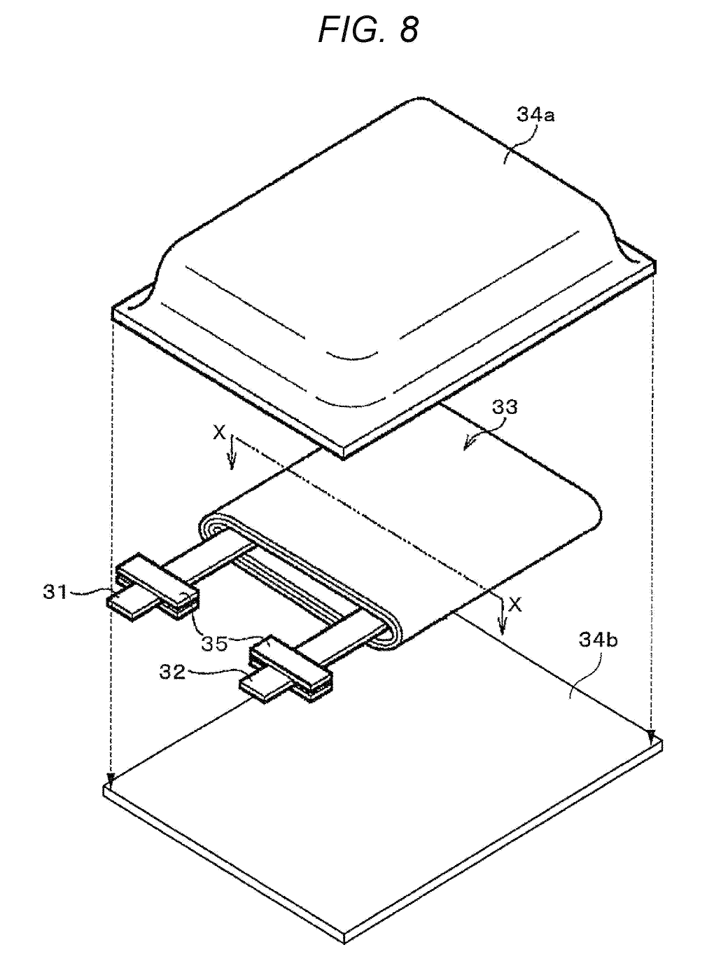

FIG. 8 is an exploded perspective view of this lithium-sulfur battery.

As shown in FIG. 8, in this lithium-sulfur battery, a wound electrode body 33 attached with a positive electrode lead 31 and a negative electrode lead 32 is housed inside of film-like exterior packaging elements 34a and 34b.

The positive electrode lead 31 and negative electrode lead 32 are drawn toward outside from the inside of the exterior packaging elements 34a and 34b, for example, in the same direction. These positive electrode lead 31 and negative electrode lead 32 are each constituted by a metal such as aluminum (Al), copper (Cu), nickel (Ni) and stainless steel. These positive electrode lead 31 and negative electrode lead 32 are constituted, for example, in the form of a thin plate or network.

The exterior packaging elements 34a and 34b are each constituted by, for example, a rectangular laminate film obtained by attaching a nylon film, an aluminum foil and a polyethylene film in this order. These exterior packaging elements 34a and 34b are disposed, for example, so that the polyethylene film sides of those and the wound electrode body 33 would face each other, and the outer edge parts of the respective exterior packaging elements are tightly bonded to each other by fusion bonding or an adhesive. Tight-adhesion films 35 for preventing the intrusion of outer air are inserted between these exterior packaging elements 34a and 34b and the positive electrode lead 31 and negative electrode lead 32. The tight-adhesion films 35 are constituted by a material having tight adhesion against the positive electrode lead 31 and negative electrode lead 32, and for example, in the case when the positive electrode lead 31 and negative electrode lead 32 are constituted by the above-mentioned metal, they are preferably constituted by a polyolefin resin such as polyethylene, polypropylene, modified polyethylene and modified polypropylene.

The exterior packaging elements 34a and 34b may also be constituted by a laminate film having another structure, a macromolecule film such as polypropylene, a metal film or the like instead of the above-mentioned laminate film.

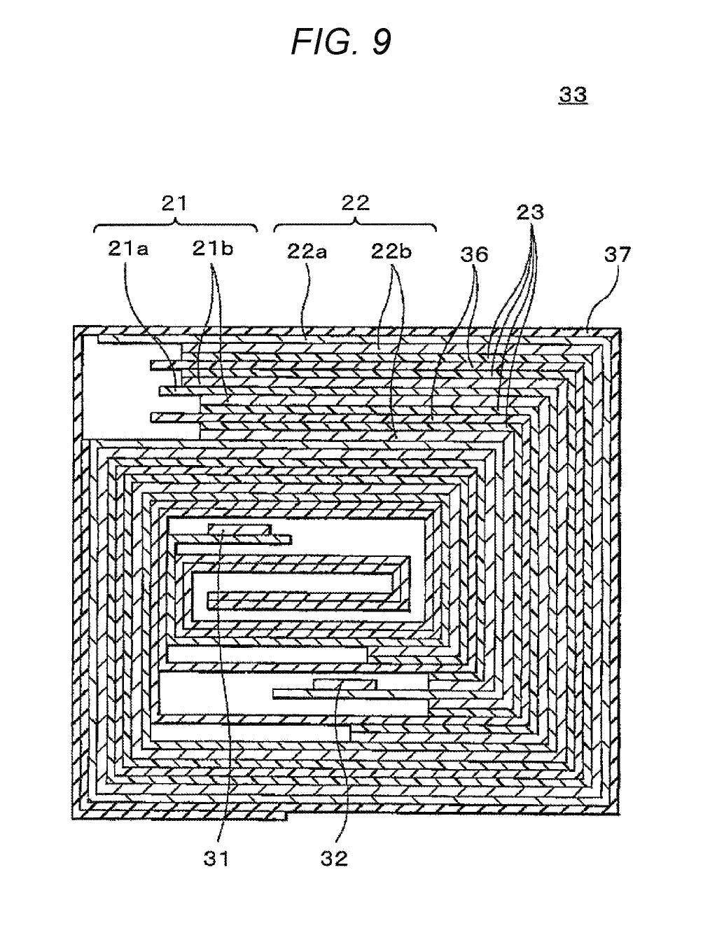

FIG. 9 shows a cross-sectional structure along the line X-X of the wound electrode body 33 shown in FIG. 8.

As shown in FIG. 9, the wound electrode body 33 is formed by laminating and winding a positive electrode 21 and a negative electrode 22 with a separator 36 and an electrolyte 23 interposed therebetween, and the outermost periphery part is protected by a protective tape 37.

The positive electrode 21 has, for example, a positive electrode current collector 21a having a pair of surfaces that are facing each other, and positive electrode mix layer(s) 21b that is/are disposed on the both surfaces or one surface of this positive electrode current collector 21a. The positive electrode current collector 21a has an exposed part on one end in the longitudinal direction thereof, on which the positive electrode mix layer 21b is not disposed, and a positive electrode lead 31 is attached to this exposed part. The positive electrode current collector 21a corresponds to, for example, the electroconductive substrate 11 of the lithium-sulfur battery shown in FIGS. 1A and 1B, and is constituted by, for example, a metal foil such as an aluminum foil, a nickel foil and a stainless steel foil. The positive electrode mix layer 21b corresponds to the carbon nanotubes 12 and sulfur 13 that are formed on the electroconductive substrate 11 of the positive electrode for a lithium-sulfur battery shown in FIG. 1A.

The negative electrode 22 has, for example, a negative electrode current collector 22a having a pair of surfaces facing each other, and negative electrode mix layer(s) 22b that is/are disposed on the both surfaces or one surface of this negative electrode current collector 22a. The negative electrode current collector 22a is preferably constituted by, for example, a metal foil such as a copper (Cu) foil, a nickel foil and a stainless steel foil, which have fine electrochemical stability, electric conductivity and mechanical strength. Among these, the copper foil is the most preferable since it has high electric conductivity. The negative electrode mix layer 22b is constituted by, for example, metallic lithium.

The separator 36 is constituted by, for example, a porous film made of a synthetic resin such as polytetrafluoroethylene, polypropylene and polyethylene, or a porous film made of a ceramic, or may have a constitution in which two or more of these porous films are laminated. Among these, porous films made of polyolefins are preferable since they are not only excellent in effect of preventing short-circuit but also capable of improving the safeness of a battery by a shut down effect. Specifically, polyethylene is preferable as a material for constituting the separator 36 since it can provide a shut down effect within the range of 100° C. or more and 160° C. or less and is also excellent in electrochemical stability. Furthermore, polypropylene is also preferable, and other resin can also be used by copolymerizing or blending with polyethylene or polypropylene as long as the resin has chemical stability.

### [Method for Manufacturing Lithium-Sulfur Battery]

This lithium-sulfur battery can be manufactured, for example, as follows.

At first, the positive electrode 21 is prepared by forming the positive electrode mix layer 21b on the positive electrode current collector 21a, and the negative electrode 22 is prepared by forming the negative electrode mix layer 22b on the negative electrode current collector 22a.

Subsequently, for example, the positive electrode lead 31 is attached to the positive electrode current collector 21a, and the electrolyte 23 is formed on the positive electrode mix layer 21b, i.e., the both surfaces or one surface of the positive electrode 21. Furthermore, the negative electrode lead 32 is attached to the negative electrode current collector 22a, and the electrolyte 23 is formed on the negative electrode mix layer 22b, i.e., the both surfaces or one surface of the negative electrode 22.

The electrolyte 23 is formed as above, and the positive electrode 21 and negative electrode 22 are then laminated. Subsequently, this laminate is wound, and the protective tape 37 is attached to the outermost periphery part to form the wound electrode body 33.

After formation of the wound electrode body 33 in such way, the wound electrode body 33 is interposed, for example, between the exterior packaging elements 34a and 34b, and the outer edge portions of the exterior packaging elements 34a and 34b are tightly attached to each other by fusion bonding or the like to thereby enclose the wound electrode body. At this time, the tight-adhesion films 35 are inserted between the positive electrode lead 31 and negative electrode lead 32 and the exterior packaging elements 34a and 34b.

By the above-mentioned way, the lithium-sulfur battery shown in FIGS. 8 and 9 is prepared.

According to this third embodiment, similar advantages to those in the second embodiment can be obtained.

Although the embodiments and Examples of the present disclosure are specifically explained above, the present disclosure is not limited to the embodiments and Examples mentioned above, and various modifications are possible.

For example, the numerical values, structures, forms, materials and the like listed in the above-mentioned embodiments and Examples are merely for exemplification, and different numerical values, structures, forms, materials and the like may be used as necessary.

Furthermore, the present disclosure can also have the following constitutions.
[1]

A secondary battery including a positive electrode including sulfur,

a negative electrode including a material that stores and releases lithium-ions,

and a nonaqueous electrolyte including lithium-ions, and the positive electrode includes

an electroconductive substrate,

a plurality of carbon nanotubes disposed in a standing manner on the electroconductive substrate,

and sulfur that is retained in at least apart of spaces among at least the carbon nanotubes.
[2]

The secondary battery according to [1], wherein the sulfur is retained in the spaces among the carbon nanotubes and on the carbon nanotubes.
[3]

The secondary battery according to [1] or [2], wherein the carbon nanotubes are oriented in the approximately vertical direction with respect to the surface of the electroconductive substrate.
[4]

The secondary battery according to any one of [1] to [3], wherein the carbon nanotubes each has a diameter of 0.8 nm or more and 20 nm or less.
[5]

The secondary battery according to any one of [1] to [4], wherein the interval between the carbon nanotubes is 20 times or less as large as the diameter of the carbon nanotube.
[6]

The secondary battery according to any one of [1] to [5], wherein the carbon nanotubes each has a length of 100 μm or less.
[7]

The secondary battery according to [6], wherein the carbon nanotubes each has a length of 20 μm or more and 50 μm or less.
[8]

A method for manufacturing a secondary battery, including a step of forming a positive electrode by retaining sulfur in at least a part of spaces among at least a plurality of carbon nanotubes that are disposed in a standing manner on an electroconductive substrate.
[9]

The method for manufacturing a secondary battery according [8], including retaining the sulfur in the spaces among the carbon nanotubes through a process of attaching the sulfur to the carbon nanotubes by spreading microparticular sulfur on the carbon nanotubes or bringing the carbon nanotubes into contact with a solution in which microparticular sulfur is dissolved.
[10]

The method for manufacturing a secondary battery according to [8] or [9], including introducing the sulfur into the spaces among the carbon nanotubes by attaching the sulfur to the carbon nanotubes by spreading microparticular sulfur on the carbon nanotubes or bringing the carbon nanotubes into contact with a solution in which microparticular sulfur is dissolved, and heating the sulfur to allow flowing.
[11]

The method for manufacturing a secondary battery according to any one of [8] to [10], wherein the sulfur is retained in the spaces among the carbon nanotubes and on the carbon nanotubes.
[12]

The method for manufacturing a secondary battery according to any one of [8] to [11], wherein the carbon nanotubes are oriented in the approximately vertical direction with respect to the surface of the electroconductive substrate.
[13]

The method for manufacturing a secondary battery according to any one of [8] to [12], wherein the interval between the carbon nanotubes is 20 times or less as large as the diameter of the carbon nanotube.
[14]

A positive electrode for a secondary battery, including an electroconductive substrate,

a plurality of carbon nanotubes that are disposed in a standing manner on the electroconductive substrate, and

sulfur that is retained at least apart of spaces among at least the carbon nanotubes.
[15]

A method for manufacturing a positive electrode for a secondary battery, including forming a positive electrode by retaining sulfur in at least a part of spaces among at least a plurality of carbon nanotubes that are disposed in a standing manner on an electroconductive substrate.
[16]

A battery pack including a secondary battery,

a control means that is configured to perform controlling relating to the secondary battery, and

an exterior packaging that is configured to enclose the secondary battery,

wherein the secondary battery includes

a positive electrode including sulfur,

a negative electrode including a material that stores and releases lithium-ions, and

a nonaqueous electrolyte including lithium-ions, and the positive electrode includes

an electroconductive substrate,

a plurality of carbon nanotubes disposed in a standing manner on the electroconductive substrate,

and sulfur that is retained in at least apart of spaces among at least the carbon nanotubes.
[17]

An electronic instrument, which is supplied with electrical power by a secondary battery, wherein the secondary battery includes a positive electrode including sulfur,

a negative electrode including a material that stores and releases lithium-ions,

and a nonaqueous electrolyte including lithium-ions,

wherein the positive electrode includes an electroconductive substrate,

a plurality of carbon nanotubes disposed in a standing manner on the electroconductive substrate,

and sulfur that is retained in at least apart of spaces among at least the carbon nanotubes.
[18]

An electric vehicle including a conversion device that is configured to be supplied with electrical power by a secondary battery and to convert the electrical power into driving force of the vehicle,

and a control device that is configured to perform information processing relating to the control on the vehicle on the basis of information relating to the secondary battery,

wherein the secondary battery includes

a positive electrode including sulfur,

a negative electrode including a material that stores and releases lithium-ions, and

a nonaqueous electrolyte including lithium-ions, and the positive electrode includes

an electroconductive substrate,

a plurality of carbon nanotubes disposed in a standing manner on the electroconductive substrate,

and sulfur that is retained in at least apart of spaces among at least the carbon nanotubes.
[19]

An electrical power system, which is configured to be supplied with electrical power from a secondary battery and/or to supply electrical power by an electrical power source to the secondary battery,

wherein the secondary battery includes

a positive electrode including sulfur,

a negative electrode including a material that stores and releases lithium-ions,

and a nonaqueous electrolyte including lithium-ions, and the positive electrode includes

an electroconductive substrate,

a plurality of carbon nanotubes disposed in a standing manner on the electroconductive substrate,

and sulfur that is retained in at least apart of spaces among at least the carbon nanotubes.
[20]

An electric power storage power source, which is configured so that an electronic instrument that is supplied with electrical power is connected to the electric power storage power source,

and includes a secondary battery,

wherein the secondary battery includes a positive electrode including sulfur,

a negative electrode including a material that stores and releases lithium-ions,

and a nonaqueous electrolyte including lithium-ions, and the positive electrode includes

an electroconductive substrate,

a plurality of carbon nanotubes disposed in a standing manner on the electroconductive substrate,

and sulfur that is retained in at least apart of spaces among at least the carbon nanotubes.

### REFERENCE SIGNS LIST

11 Electroconductive substrate
12 Carbon nanotubes
13 Sulfur
13a Sulfur microparticles
21 Positive electrode
21a Positive electrode current collector
21b Positive electrode mix layer
22 Negative electrode
22a Negative electrode current collector
22b Negative electrode mix layer
23 Electrolyte
31 Positive electrode lead
32 Negative electrode lead
33 Wound electrode body
34a Exterior packaging element
34b Exterior packaging element
35 Tight-adhesion films
36 Separator
37 Protective tape

1. A secondary battery comprising a positive electrode comprising sulfur,
a negative electrode comprising a material that stores and releases lithium-ions,
and a nonaqueous electrolyte comprising lithium-ions, and the positive electrode comprises an electroconductive substrate,
a plurality of carbon nanotubes disposed in a standing manner on the electroconductive substrate,
and sulfur that is retained in at least a part of spaces among at least the carbon nanotubes.

2. The secondary battery according to claim 1, wherein the sulfur is retained in the spaces among the carbon nanotubes and on the carbon nanotubes.

3. The secondary battery according to claim 2, wherein the carbon nanotubes are oriented in the approximately vertical direction with respect to the surface of the electroconductive substrate.

4. The secondary battery according to claim 3, wherein the carbon nanotubes each has a diameter of 0.8 nm or more and 20 nm or less.

5. The secondary battery according to claim 4, wherein the interval between the carbon nanotubes is 20 times or less as large as the diameter of the carbon nanotube.

6. The secondary battery according to claim 5, wherein the carbon nanotubes each has a length of 100 μm or less.

7. The secondary battery according to claim 6, wherein the carbon nanotubes each has a length of 20 μm or more and 50 μm or less.

8. A method for manufacturing a secondary battery, comprising a step of forming a positive electrode by retaining sulfur in at least a part of spaces among at least a plurality of carbon nanotubes that are disposed in a standing manner on an electroconductive substrate.

9. The method for manufacturing a secondary battery according to claim 8, comprising retaining the sulfur in the spaces among the carbon nanotubes through a process of attaching the sulfur to the carbon nanotubes by spreading microparticular sulfur on the carbon nanotubes or bringing the carbon nanotubes into contact with a solution in which microparticular sulfur is dissolved.

10. The method for manufacturing a secondary battery according to claim 9, comprising introducing the sulfur into the spaces among the carbon nanotubes by attaching the sulfur to the carbon nanotubes by spreading microparticular sulfur on the carbon nanotubes or bringing the carbon nanotubes into contact with a solution in which microparticular sulfur is dissolved, and heating the sulfur to allow flowing.

11. The method for manufacturing a secondary battery according to claim 10, wherein the sulfur is retained in the spaces among the carbon nanotubes and on the carbon nanotubes.

12. The method for manufacturing a secondary battery according to claim 11, wherein the carbon nanotubes are oriented in the approximately vertical direction with respect to the surface of the electroconductive substrate.

13. The method for manufacturing a secondary battery according to claim 12, wherein the interval between the carbon nanotubes is 20 times or less as large as the diameter of the carbon nanotube.

14. A positive electrode for a secondary battery, comprising an electroconductive substrate,
a plurality of carbon nanotubes that are disposed in a standing manner on the electroconductive substrate, and
sulfur that is retained at least a part of spaces among at least the carbon nanotubes.

15. A method for manufacturing a positive electrode for a secondary battery, comprising forming a positive electrode by retaining sulfur in at least a part of spaces among at least a plurality of carbon nanotubes that are disposed in a standing manner on an electroconductive substrate.

16. A battery pack comprising a secondary battery,
a control means that is configured to perform controlling relating to the secondary battery, and
an exterior packaging that is configured to enclose the secondary battery,
wherein the secondary battery comprises
a positive electrode comprising sulfur,
a negative electrode comprising a material that stores and releases lithium-ions, and
a nonaqueous electrolyte comprising lithium-ions, and the positive electrode comprises
an electroconductive substrate,
a plurality of carbon nanotubes disposed in a standing manner on the electroconductive substrate,
and sulfur that is retained in at least a part of spaces among at least the carbon nanotubes.

17. An electronic instrument, which is supplied with electrical power by a secondary battery, wherein the secondary battery comprises a positive electrode comprising sulfur,
a negative electrode comprising a material that stores and releases lithium-ions,
and a nonaqueous electrolyte comprising lithium-ions,
wherein the positive electrode comprises an electroconductive substrate,
a plurality of carbon nanotubes disposed in a standing manner on the electroconductive substrate,
and sulfur that is retained in at least a part of spaces among at least the carbon nanotubes.

18. An electric vehicle comprising a conversion device that is configured to be supplied with electrical power by a secondary battery and to convert the electrical power into driving force of the vehicle,
and a control device that is configured to perform information processing relating to the control on the vehicle on the basis of information relating to the secondary battery,
wherein the secondary battery comprises
a positive electrode comprising sulfur,
a negative electrode comprising a material that stores and releases lithium-ions, and
a nonaqueous electrolyte comprising lithium-ions, and the positive electrode comprises
an electroconductive substrate,
a plurality of carbon nanotubes disposed in a standing manner on the electroconductive substrate,
and sulfur that is retained in at least apart of spaces among at least the carbon nanotubes.

19. An electrical power system, which is configured to be supplied with electrical power from a secondary battery and/or to supply electrical power by an electrical power source to the secondary battery,
wherein the secondary battery comprises a positive electrode comprising sulfur,
a negative electrode comprising a material that stores and releases lithium-ions,
and a nonaqueous electrolyte comprising lithium-ions, and the positive electrode comprises
an electroconductive substrate,
a plurality of carbon nanotubes disposed in a standing manner on the electroconductive substrate,
and sulfur that is retained in at least apart of spaces among at least the carbon nanotubes.

20. An electric power storage power source, which is configured so that an electronic instrument that is supplied with electrical power is connected to the electric power storage power source,
and comprises a secondary battery,
wherein the secondary battery comprises a positive electrode comprising sulfur,
a negative electrode comprising a material that stores and releases lithium-ions,
and a nonaqueous electrolyte comprising lithium-ions, and the positive electrode comprises
an electroconductive substrate,
a plurality of carbon nanotubes disposed in a standing manner on the electroconductive substrate,
and sulfur that is retained in at least a part of spaces among at least the carbon nanotubes.
